(19) United States
(12) Patent Application Publication
(10) Pub. No.: US 2010/0098429 A1
(43) Pub. Date: Apr. 22, 2010

(54) MULTI-APERTURE OPTICAL DETECTOR AND OPTICAL SIGNAL DETECTING CIRCUIT COMPRISING THE SAME

(75) Inventors: Yong-Il Jun, Daejeon (KR); Wangjoo Lee, Daejeon (KR); Tae-Joon Park, Daejeon (KR); Young-Boo Kim, Chungcheongnam-do (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/517,783

(22) PCT Filed: Dec. 5, 2007
(86) PCT No.: PCT/KR07/06286

§ 371 Date: Jun. 4, 2009

(30) Foreign Application Priority Data
Dec. 5, 2006 (KR) 10-2006-0122545

(51) Int. Cl. H04B 10/12

(52) U.S. Cl. 398/141

(57) ABSTRACT

Provided are a multi-aperture optical detector that can address structural problems such as a complex signal wiring in array type optical detectors, and a need for a plurality of low noise amplifiers, signal to noise ratio detectors, etc., and an optical signal detecting circuit including the multi-aperture optical detector. The multi-aperture optical detector includes transmission lines having two output terminals; and a plurality of unit optical detectors which respectively have random polarities through the transmission lines and are connected in parallel, and optical signals from each of the unit optical detectors are added and output through the two output terminals. The multi-aperture optical detector has a high operation band width and can detect optical signals with a high sensitivity by connecting a plurality of unit optical detectors that respectively have a low optical detecting sensitivity and are physically compact and small.

### TECHNICAL FIELD

The present invention relates to an optical communication device, and more particularly, to an optical detector for direct detection of an optical signal and an optical signal detecting circuit comprising the optical detector.

### BACKGROUND ART

The information era is moving fast toward the development of ubiquitous environments where various devices can be connected to information networks and users can be provided with convenient services anytime and anywhere. Wireless techniques are widely used for terminal connections in ubiquitous networks due to the convenience of codeless communication, mobility, location, etc.

In nowadays wireless communication technologies, an RF/MW wavelength band from several MHz to tens of GHz is mainly used, a speed of service is relatively low compared to wire technologies, the wavelength band should be used in common with a plurality of users and a plurality of applications such as satellite communications, military communications, etc., physical security of information is not provided, and output waves might harm the human body.

Optical wireless communication where information is communicated through space light propagation can be an alternative technology to overcome the above-described problems of the conventional wireless communication technologies. In this case, the receiving features of optical communication devices are determined by the received electric power. Methods of increasing the received electric power include increasing a transmitting amount of optical power, reducing a path loss, increasing the area of a receiver antenna or a lens, improving the noise features of a receiver, etc.

FIG. 1 is a cross-sectional view illustrating a conventional optical detector.

Referring to FIG. 1, an optical detector 10 includes an object lens 11, a ball lens 12, and a photo diode 13. The photo diode 13 is attached to a package 17 via a chip mount 16 and outputs detected-photo-currents through output terminals 14 and 15. The conventional optical detector operates as follows. The object lens 11 initially condenses light incident onto an aperture of the ball lens 12. The condensed light is again condensed by the ball lens 12 and absorbed into a depletion layer of the photo diode 13. The light that is absorbed to the depletion layer of the photo diode 13 generates a number of electron-holes proportional to the optical power of the light. The generated electron-holes are accelerated by a strong reverse-bias voltage that is applied to the depletion layer and are finally transmitted as a detected current to the output terminals 14 and 15.

The size of the aperture of the object lens 11 determines the absolute amount of light incident on the photo diode 13. Thus, the aperture of the objective lens 11 should be as large as possible in order to increase the sensitivity of the optical detector. However, an objective lens having a large aperture has a relatively long focal length and a relatively narrow field of view. These disadvantages can be addressed by using the ball lens 12. The ball lens 12 widens the field of view and reduces a physical thickness of the optical detector 10.

The photo diode 13 should have a broad depletion layer which absorbs light, a small parasitic capacitance for a broadband operation, and a high reverse-bias resistance for an efficient combining of the detected signal.

FIG. 2 is a circuit diagram of an optical detector 50 in which a bias circuit is added to a conventional optical detector.

Referring to FIG. 2, Indictors 20-1 and 20-2 should have a high impedance value as mush as possible in order to separate the optically detected signals and bias currents. Resistances 30-1 and 30-2 are used to restrict a DC current that can flow to the photo diode 13. A capacitor 45 is connected in parallel with a DC power supply 40 in order to stabilize the DC voltage.

In the above-mentioned conventional optical detector using a single photo diode, the aperture of the objective lens 11 should be large in order to collect more signal light. On the other hand, the lens having the large aperture is heavy and has a long focal length. Accordingly, the volume and the weight of optical detectors increase, and a high degree of precision is required in the manufacturing process. In addition, the field of view of the optical detector becomes narrow as the aperture of the objective lens becomes large.

To address these problems of the optical detector of FIG. 1, increasing a total effective area of the aperture using a plurality of optical detectors that respectively have a small aperture has been suggested.

FIG. 3 shows a circuit diagram of an optical signal detecting circuit including a conventional array type optical detector, which was disclosed in ‘Angle Diversity and Rate-Adaptive Transmission for Indoor Wireless Optical Communications’ by Antonio Tavares, Rui Valadas, Rui L. Aguiar, and A. Oliveira Duarte published in IEEE Communications Magazine, pp. 64˜73, March 2003.

Referring to FIG. 3, the conventional optical signal detecting circuit includes a plurality of unit optical detectors 50-1, . . . , 50-N which respectively include an objective lens having a small aperture in an array type, a plurality of low noise amplifiers (LNAs) 60-1, . . . , 60-N which amplify optical power signals that are detected in the unit optical detectors 50-1, . . . , 50-N, signal-to-noise (S/N) ratio detectors 70-1, . . . , 70-N which generate gain control signals of LNAs proportional to the S/N ratio of the detected optical power signals, and a combiner 80 which combines the amplified optical power signals.

When the operation mode of the optical signal detecting circuit is a ‘Select Best’ mode, the combiner 80 selects and outputs the amplified output signal of the unit optical detector that has the greatest S/N ratio, and the amplification gains of the LNAs 60-1, . . . , 60-N are set to a fixed value that is determined by a feature of an optical system. When the operation mode of the optical signal detecting circuit is a ‘Maximal Ratio Combining’ mode, the combiner 80 simply adds the output signals of the LNAs 60-1, . . . , 60-N, and the amplification gains of the LNAs 60-1, . . . , 60-N are determined proportionately to the S/N ratio of the output optical power of respective unit optical detectors. When the operation mode of the optical signal detecting circuit is an ‘Equal Gain Combining’ mode, the combiner 80 simply adds the output signals of the LNAs 60-1, . . . , 60-N, and the amplification gains of the LNAs 60-1, . . . , 60-N are set to a fixed value that is determined by a feature of the optical system.

The array-type optical detector of the optical signal detecting circuit of FIG. 3 can offset the above-described problems of the optical detector in FIG. 1. Due to the structure having a plurality of small objective lens, the volume and the weight of the optical detector can be decreased. At the same time, the problem of the lens manufacturing precision can be addressed. Also, the narrow field of view can be widened and the photo sensitivity can be increased by directing the small objective lens of the array-type optical detectors toward various directions.

However, the conventional optical signal detecting circuit using the array-type optical detectors requires as many low noise amplifiers (LNAs) 60-1, . . . , 60-N and S/N ratio detectors 70-1, . . . , 70-N as the number of the unit optical detectors 50-1, . . . , 50-N, and thus signal wirings for connecting them become complicated. In addition, when a digital combiner 80 is used, the optical signal detecting circuit should further include a plurality of analog-to-digital converters corresponding to the unit optical detectors.

### DISCLOSURE OF INVENTION

### Technical Problem

The present invention provides an optical detector and an optical signal detecting circuit including the same, which address problems related to complicated signal wiring, a need for a plurality of low noise amplifiers and signal-to-noise ratio detectors, etc.

### Technical Solution

According to an aspect of the present invention, there is provided a multi-aperture optical detector including transmission lines having two output terminals; and a plurality of unit optical detectors which respectively have random polarities through the transmission lines and are connected in parallel, wherein optical signals from each of the unit optical detectors are added and output through the two output terminals.

The unit optical detector may include an objective lens condensing light; a ball lens condensing again the light that is condensed by the objective lens; and a photo diode (PD) receiving the light that is condensed by the ball lens and generating a photo detected electrical current.

The photo diode (PD) may include a depletion layer which receives light and generates an electric current, and a high reverse-bias voltage is applied to the depletion layer.

The transmission lines may be formed by using one of strip lines, microstrip lines, coaxial lines, unshielded twisted pair (UTP) wires, and shielded twisted pair (STP) wires.

The transmission lines may be formed by using elements of a lumped constant circuit including a resistance, a capacitor, and an inductor.

The two output terminals may output the same optical signals having the same phase.

A matched impedance circuit which is conjugate-matched to the output impedance may be formed at one of the two output terminals.

The output impulse response characteristic of the unit optical detectors may have a parallel combination pattern in which several column vectors or row vectors of a Hadamard matrix are combined, and the multi-aperture optical detector may separately detect optical pulse signals transmitted with intervals of column vectors or row vectors of the Hadamard matrix.

The output impulse response characteristic of the unit optical detectors may have a parallel combination pattern in which several column vectors or row vectors of an orthogonal matrix are combined, and the multi-aperture optical detector may separately detect optical pulse signals transmitted with intervals of column vectors or row vectors of the orthogonal matrix.

According to another aspect of the present invention, there is provided an optical signal detecting circuit including a multi-aperture optical detector of claim 1; two low noise amplifiers (LNAs) that are respectively connected to the two output terminals; two sample holders which sample and maintain the signals that are output from each of the LNAs; two analog to digital (A/D) converters which convert the signals that are sampled and maintained in each of the sample holders into digital signals; and an adder which adds the digital signals from each of the A/D converters.

The information transmission capacity of the optical signal detecting circuit in which N unit optical detectors may be used for the multi-aperture optical detector is as high as log₂(1+N) times the information transmission capacity of the optical signal detecting circuit in which a single unit optical detector is used.

### ADVANTAGEOUS EFFECTS

The multi-aperture optical detector or the optical signal detecting circuit of the present invention can have a physically compact small aperture while having a high operating bandwidth and can detect optical signals with a high sensitivity by connecting a plurality of unit optical detectors having a low optical sensitivity.

Also, the multi-aperture optical detector using N unit optical detectors has an information transmission capacity that is a maximum of log₂(1+N) times that of the unit optical detector. Thus, the multi-aperture optical detector of the present invention can be used for optical wireless communicators, millimeter wave communicators, etc., by being combined with a ‘unipolar OFDM’ device or a conventional modulation and demodulation device.

Further, a highly sensitive optical wireless communicator using the multi-aperture optical detector of the present invention can be used in indoor broadband backbones, plant and industrial machine control backbones, and space communications in the future.

While the present invention has been particularly shown and described with reference to exemplary embodiments thereof, it will be understood by those of ordinary skill in the art that various changes in form and details may be made therein without departing from the spirit and scope of the present invention as defined by the following claims.

### DESCRIPTION OF DRAWINGS

The above and other features and advantages of the present invention will become more apparent by describing in detail exemplary embodiments thereof with reference to the attached drawings in which:

FIG. 1 is a cross-sectional view of a conventional optical detector;

FIG. 2 is a circuit diagram of an optical detector in which a bias circuit is added to a conventional optical detector;

FIG. 3 is a circuit diagram of an optical signal detecting circuit including conventional array type optical detectors;

FIG. 4 is a circuit diagram of a multi-aperture optical detector including a plurality of unit optical detectors according to an embodiment of the present invention;

FIG. 5 is a graph illustrating an improvement rate of the Shannon performance of the multi-aperture optical detector of FIG. 4; and

FIG. 6 is a circuit diagram of an optical signal detecting circuit including the multi-aperture optical detector of FIG. 4 according to another embodiment of the present invention.

### BEST MODE

The present invention will now be described more fully with reference to the accompanying drawings, in which exemplary embodiments of the invention are shown. Hereinafter, when an element is described to be disposed above another element, the element can be disposed directly on another element or a third element can be interposed between the two elements. Also, the thickness or the size of each element is exaggerated for a better understanding of the present invention, and parts that are not related to the description are omitted in the drawings. Like reference numerals used in the drawings refer to like elements. The terms used herein are only intended for explaining the present invention, and do not limit the meaning or scope of the present invention.

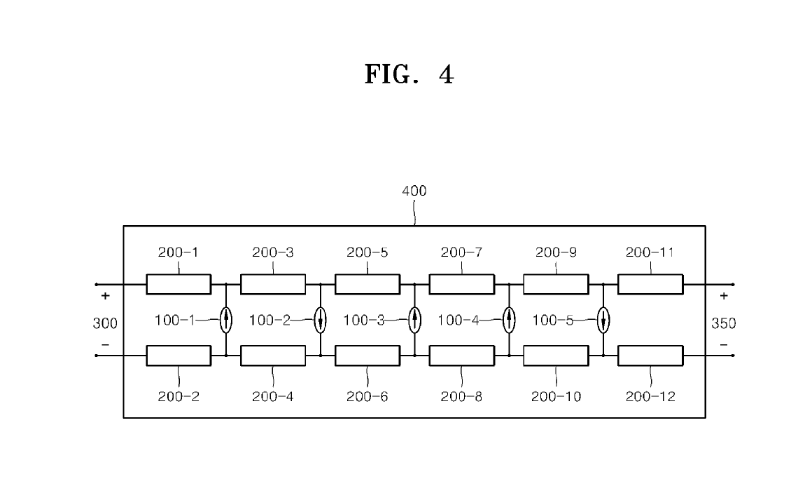

FIG. 4 is a circuit diagram of a multi-aperture optical detector including a plurality of unit optical detectors according to an embodiment of the present invention.

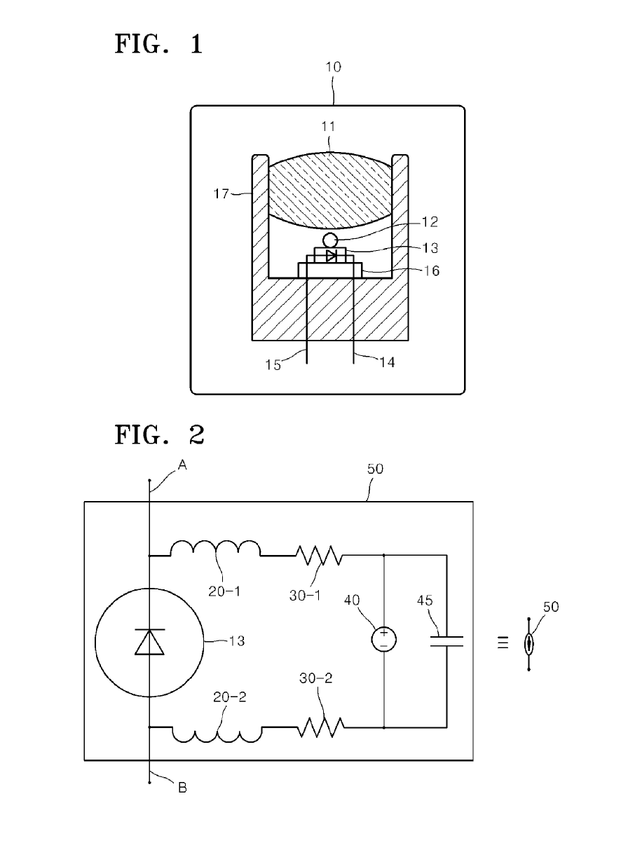

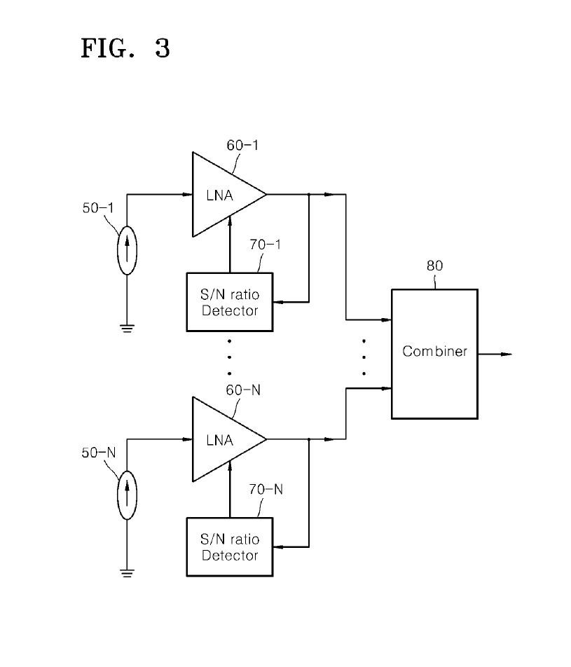

Referring to FIG. 4, the multi-aperture optical detector 400 of the present invention includes transmission lines 200-1, . . . , 200-12 having two output terminals 300 and 350, and a plurality of unit optical detectors 100-1, . . . , 100-5 that are connected in parallel and have different polarities. Each of the unit optical detectors 100-1, . . . , 100-5 has the same stricture as illustrated in FIG. 1, and a bias circuit as illustrated in FIG. 2 can be combined with each of the unit optical detectors to enhance the sensitivity of the optical detectors. Although five unit optical detectors and six transmission lines are formed in the current embodiment, the number of the unit optical detectors and the transmission lines can change. Also, the unit optical detectors can be connected to the transmission lines with a random polarity direction as illustrated in FIG. 4 to increase the optical transmission capacity.

When unit transmission lines 200-(2k−1)(odd) and 200-(2k)(even) constituting a transmission line are in a form of a microstrip, upper transmission lines 200-(2k−1) correspond to strip wires and lower transmission lines 200-(2k) correspond to ground planes, or vice versa. The transmission line can be formed in a conventional form of a coaxial line, an unshielded twisted pair (UTP) wire, a shielded twisted pair (STP) wire, or the like, or in a form of a π-type or a t-type lumped constant network including elements such as a resistor, a capacitor, and an inductor.

The following equations are satisfied

dₖ=\sqrt{lₖcₖ}

and

zₖ=\sqrt{lₖ/cₖ}

, where cₖ is a total capacitance constituting (k)th unit transmission lines 200-(2k−1) and 200-(2k), lₖ is a total indictor constituting the (k)th unit transmission lines 200-(2k−1) and 200-(2k), dₖ is an electric current transmission delay of the (k)th transmission lines 200-(2k−1) and 200-(2k), and zₖ is a total impedance. Also, the transmission line can be formed as a partial circuit of a filter having a band pass characteristic which is required in a system, an electric current transmission delay dₖ, and a line impedance zₖ.

An attaching polarity of unit optical detectors to the transmission lines can have a structure of a combination of several column vectors or row vectors of a Hadamard matrix or an orthogonal matrix so that the impulse response characteristic of the two output terminals can be defined by a combination of several column vectors or row vectors of a Hadamard matrix or an orthogonal matrix, and the multi-aperture optical detector can separate and detect optical pulse signals that are transmitted with an interval of the magnitude of the Hadamard matrix or the orthogonal matrix under an ideal channel environment or a channel environment that is equalized by an equalizer.

The multi-aperture optical detector of the current embodiment operates as follows.

An impulse optical signal incident on a (k)th unit optical detector 100-k is detected and changed into an impulse optical current having a magnitude of 2aₖ. The magnitude 2aₖ of the optical current is determined according to the characteristic of the unit optical detector, and a main determining factor is the size of the aperture of the objective lens which determines the quantity of the incident light. When the output impedance of the unit optical detector is much greater than the impedance of the transmission line, almost all the detected optical current flows to the two output terminals 300 and 350 and the magnitude is respectively aₖ. When impulse optical signals are applied to all unit optical detectors, an impulse response characteristic h₁(t) of the left output terminal 300 and an impulse response characteristic hᵣ(t) of the right output terminal 350 respectively satisfy t Equations (1) and (2).

$$\begin{matrix}{h}_{l} ( t ) = {\sum }_{k = 0}^{N - 1} {α}_{k} δ ( t - {\sum }_{i = 0}^{k} {d}_{i} ) & Equation ( 1 ) \\ {h}_{r} ( t ) = {\sum }_{k = 0}^{N - 1} {α}_{k} δ ( t - {\sum }_{i = 0}^{N - k - 1} {d}_{N - i} ) & Equation ( 2 )\end{matrix}$$

When the electric current transmission delay of all the unit transmission lines is uniformly T₀, the impulse response characteristics of the output terminals 300 and 350 are expressed by the following equation.

$$\begin{matrix}{h}_{l} ( t ) = {\sum }_{k = 0}^{N - 1} {α}_{k} δ ( t - ( k + 1 ) {T}_{0} ) & Equation ( 3 ) \\ {h}_{r} ( t ) = {\sum }_{k = 0}^{N - 1} {α}_{k} δ ( t + {kT}_{o} - {NT}_{o} ) & Equation ( 4 )\end{matrix}$$

Equations (3) and (4) are the impulse responses of a typical finite impulse response (FIR) filter. Therefore, the impulse response characteristics of the optical detector of the present invention are the same as the operational characteristics of known FIR filters.

Hereinafter, the effects of the multi-aperture optical detector of the present invention are described in comparison to the conventional single-aperture optical detector.

For a simple and general explanation, the response characteristic of the multi-aperture optical detector of the present invention is represented by Equation (3). Equation (3) is a permutation of the impulse over a time interval T₀. Thus, the impulse response can be written as a row vector,

x [symbol] =[a₀ a₁ . . . a_{N-1} 0 . . . 0].

That is, the impulse response h₁(t) is represented by a row vector
x [symbol]
   that has n elements which are N impulses and (n-N) zeros added thereto. A Fourier transformation vector of the vector
x [symbol]
   is written as Equation (5) below when a frequency response row vector is

$$\text{?} = [ \begin{matrix}{b}_{0} & {b}_{1} & … & {b}_{N - 1} & {b}_{N} & … & {b}_{x - 1}\end{matrix} ] \\ \text{?} = \underline{\underline{F}} \text{?} , \\ \text{?} \text{indicates text missing or illegible when filed} \qquad Equation ( 5 )$$

where
F
   refers to an n×n discrete Fourier transform (DFT) matrix, a superscript t refers to an operator of transposition. Therefore,
F
   is a square matrix of which element in a (g)th row and a (h)th column is

exp(−j2π(g−1)(h−1)/n).

### Therefore,

x [symbol]
   is a row vector having n elements representing a response characteristic of frequency band from −½T₀ to ½T₀.

If the operating band of the unit optical detectors is sufficiently broader than ½T₀, the maximum speed of transmitting information, Iₚ, of the optical detector of the present invention is written as Equation (6) according to the well-known Shannon's Law, and the maximum speed of transmitting information is called ‘Shannon performance’ herein. In Equation (6), cᵢ is a noise current in the optical detector at a frequency of i. In Equation (6), m is n/2 when n is an even number, and m is (n−1)/2 when n is an odd number.

$${I}_{p} = {\sum }_{i = 0}^{m} ( 1 / n {T}_{0} ) {log}_{2} ( 1 + {\vert {b}_{i} \vert}^{2} / {\vert {c}_{i} \vert}^{2} ) \qquad Equation ( 6 )$$

The maximum limit of the Shannon performance is derived using the inequality relationship between the arithmetical mean and the geometrical mean and the Parseval's theorem. It is supposed that thermal noise vector elements are white noise and thus have a unit value. Therefore, when the noise current satisfies

|cᵢ|²=1

for all frequency, the maximum limit of the Shannon performance of the present invention is inversely proportional to the electric current transmission delay T₀ of the unit transmission line and directly proportional to the log of the square of the total light receiving area of the optical detector, and is expressed as Equation (7). In Equation (7), a light receiving area bᵢ corresponds to a magnitude of the detected optical current aᵢ as explained below. When the arithmetical mean and the geometrical mean are equal to each other, the left and right terms in Equation (7) become equal only when

$${\vert {b}_{k} \vert}^{2} = {\sum }_{i = 0}^{N - 1} {a}_{i}^{2}$$

with respect to all wavelengths. That is, when the wavelength response characteristic uniformly satisfies the equation

$${\vert {b}_{k} \vert}^{2} = {\sum }_{i = 0}^{N - 1} {a}_{i}^{2} .$$

the optical detector of the present invention can have the mathematical maximum limit of the Shannon performance.

$${I}_{p} \leq ( 1 / 2 {T}_{0} ) {log}_{2} ( 1 + {\sum }_{i = 0}^{N - 1} {a}_{i}^{2} ) \qquad Equation ( 7 )$$

The condition for the mathematical maximum limit of the Shannon performance can satisfy Equation (5) only when a single unit optical detector is installed in FIG. 4, that is, only when Equation (3), which is the impulse response, is expressed as a single impulse function only. That is, the above described condition does not allow the receiving gain, which is a purpose of the present invention, to be obtained.

The optimal performance which can be obtained by the optical detector warding to the present invention is derived below. If the maximum possible response of a unit optical detector which can be embodied is expressed as ‘1 ’ and the unit optical detector having a bandwidth sufficiently broader than ½T₀, the strength of the response characteristic of the unit optical detectors that can be installed in the circuit of the present invention in FIG. 4 is expressed as Equation (8). When

|cᵢ|²=1 ,

the Shannon performance of Equation (6) can be expressed as Equation (9). In Equation (10),
fₖ
   is a (k)th row vector of the DFT matrix,
fₖ^{H}
   is a Hermitian column vector of
fₖ,
   and
Hₖ
   is an n×n square matrix of a column
fₖ^{H}
   times a row

$$\begin{matrix}{\underline{f}}_{k} . \\ - 1 \leq {a}_{j} \leq 1 , j = 0 , ∼ N - 1 & Equation ( 8 ) \\ - {I}_{p} = - ( 1 / n {T}_{0} ) {log}_{2} {\prod }_{k = 0}^{m} ( 1 + {\underline{x}}_{p} {\underline{\underline{H}}}_{k} \text{?} ) & Equation ( 9 ) \\ {\underline{\underline{H}}}_{k} = {\underline{f}}_{k}^{H} {\underline{f}}_{k} \\ \text{?} \text{indicates text missing or illegible when filed} & Equation ( 10 )\end{matrix}$$

Equation (8) for the strength of the unit optical detectors that are installable and Equation (9) for the Shannon performance constitute a typical non-linear optimization problem in which variable values are limited. That is, the optimization of performance of the present invention becomes a matter of seeking a minimum value for Equation (9) under the condition that Equation (8) is satisfied. Thus, Equations (8) and (9) are expressed using the Lagrange function as Equation (11). In Equation (11), the Lagrange variable vectors
π
   and
λ
   are respectively row vectors consisting of N Lagrange variables.

$$L ( {\underline{x}}_{p} , \underline{π} , \underline{λ} ) = - {I}_{p} ( {\underline{x}}_{p} ) + \underline{π} \cdot ( \text{?} - 1 ) - \underline{λ} \cdot ( \text{?} + \underline{1} ) ∵ \underline{π} \geq \underline{0} , \underline{λ} \geq \underline{0} \\ \text{?} \text{indicates text missing or illegible when filed} \qquad Equation ( 11 )$$

A necessary condition hat the Lagrange function defined by Equation (11) has a minimum value is given by Equation (12). Therefore, if the variable vectors of the optimal point, at which Equation (11) has the minimum value, are
x^{o} [symbol] ,π^{o},λ^{o},
   the value of a first order partial differential vector of the vector
x [symbol]
   for the Lagrange function should be ‘0 ’ at the optimal point
x^{o} [symbol] , π^{o}, λ^{o}.

∇ₓ_{ₒ}L(x^{o}z,999 ,π^{o},λ^{o})=0 Equation (12)

The necessary conditions for the optimal point in Equation (12) are classified into three groups when applying the necessary conditions for ‘Karush-Kuhn-Tucker’ non-linear optimization according to the values of the elements of the vector
x

[symbol]

Two groups are expressed as Equation (13) and Equation (14). Equation (13), which is the first group of the necessary conditions for the optimal point, represents a boundary condition −1<aⱼ<1, that is, represents cases where the element values of the vector
x [symbol]
   are outside the boundary points and an limitless optimization is effective. In this case, the partial differential,
∇ₓ_{ₒ}I [symbol] ,
   of the Shannon performance function can have the optimal point only when a solution equal to ‘0 ’ exists within a boundary condition of the vector
x [symbol] .

∇ₓ_{ₒ}I [symbol] (x^{o} [symbol] )=0, π^{o}=0, λ^{o}=0, −1<aⱼ<1 Equation (13)

−∇ₓ_{ₒ}I [symbol] (x^{o}ₚ)+π^{o}−λ^{o}=0, π^{o}>0, λ^{o}>0, |aⱼ|=1 Equation (14)

The partial differential function
∇ₓ_{ₒ}I [symbol]
   of the Shannon performance function is given by Equation (15). Bemuse
x [symbol] Hₘx [symbol] ≧0,
   the elements of Equation (15),

$${\prod }_{m = 0}^{m} ( 1 + {\underline{x}}_{p} {\underline{\underline{H}}}_{m} \text{?} )$$

$$and$$

$${\prod }_{{j \neq k}_{j = 0}}^{m} ( 1 + {\underline{x}}_{p} {\underline{\underline{H}}}_{j} \text{?} )$$

$$\text{?} \text{indicates text missing or illegible when filed}$$

are always greater than ‘1.’ Accordingly,
∇ₓ_{ₒ}(−I [symbol] )
   is written as the last term in Equation (15).

$$\begin{matrix}\begin{matrix}{∇}_{{\underline{x}}_{o}} ( - {l}_{p} ) = ( 1 / log 2 ) ( 1 / n {T}_{o} ) {\prod }_{n = 0}^{m} ( 1 + {\underline{x}}_{p} {\underline{\underline{H}}}_{n} \text{?} ) \cdot {\sum }_{k = 0}^{m} \\ [ \{ {\prod }_{{j \neq k}_{j = 0}}^{m} ( 1 + {\underline{x}}_{p} {\underline{\underline{H}}}_{j} \text{?} \text{?} ) \} ( \text{?} + {\underline{\underline{H}}}_{k} ) \text{?} ] \\ = {\sum }_{k = 0}^{m} {d}_{k} ( \text{?} + {\underline{\underline{H}}}_{k} ) \text{?} ,\end{matrix} & Equation ( 15 ) \\ \text{?} \text{indicates text missing or illegible when filed} & \end{matrix}$$

where dₖ is a particular constant greater than ‘1.’ Also, the matrix sum

$${\sum }_{k = 0}^{m} {d}_{k} ( \text{?} + {\underline{\underline{H}}}_{k} )$$

$$\text{?} \text{indicates text missing or illegible when filed}$$

consists of the sum of the element matrices
(H [symbol] ₖ+Hₖ).
   An element matrix
(H [symbol] ₖ+Hₖ)
   is
(fₖ [symbol] fₖ^{o}+fₖ^{H}fₖ)
   according to Equation (10). Therefore, since the discrete Fourier transform (DFT) row vector
fₖ
   is an element row vector of a full rank n×n DFT matrix, the rank of the
(H [symbol] ₖ+Hₖ)
   of the matrix is ‘1 ’ when
fₖ
   is a real vector, and the rank of the
(H [symbol] ₖ+Hₖ)
   of the matrix is ‘2’ when
fₖ
   is an imaginary vector. According to the features of an n×n DFT matrix, the conditions that
fₖ
   is a real vector are k=1 and k=n/2 if n is even, and k=0 if n is odd. Therefore, ‘two’ real
fₖ
   vectors exist if n is even, and ‘one’ real vector
fₖ
   exists if n is odd. Thus, the matrix

$${\sum }_{k = 0}^{m} {d}_{k} ( \text{?} + {\underline{\underline{H}}}_{k} )$$

$$\text{?} \text{indicates text missing or illegible when filed}$$

is a full rank matrix, and no Null space exists. Therefore, the point
x [symbol] ^{o},π^{o},λ^{o}
   satisfying Equation (13) does not exist. In other words, when all the elements of the vector
x [symbol]
   satisfy −1<aⱼ<1, the optimal point
xz,999 ^{o},π^{o},λ^{o}
   which maximizes the Shannon performance does not exist.

The second group, which is a necessary condition for the optimal point represented by Equation (14), represents cases where
   |aⱼ|=1 ,
   which means that all element values of the vector
x [symbol]
   exist on the boundary of the boundary condition, that is, cases where the boundary condition is active. In this case, the partial differential
∇ₓ_{ₒ}I [symbol]
   of the Shannon performance function has a value of a particular real number at the optimal point vector
x [symbol] ^{o}.
   Also, since the Lagrange variable vectors are real numbers that satisfy
π^{o}>0, λ^{o}>0,
   solutions satisfying Equation (14) exist. Also, the maximum number of cases that satisfy
   |aⱼ|=1
   is 2^{N}. Therefore, the condition for the optimal performance of the present invention and the optimal
x [symbol] ^{o}
   can be obtained by calculating the maximum value of the Shannon performance given by Equation (9) at
x [symbol]
   that corresponds to the 2^{N} number of cases.

The third group relates to the conditions where a part of the elements of
x [symbol] ^{o}
   satisfies −1<a<1, and another part of the elements satisfies
   |a [symbol] |=1.
   In this case, (j)th elements of the partial differential vector function
∇ₓ_{ₒ}I [symbol]
   of the Shannon performance function satisfying −1<aⱼ<1 should be ‘0.’ Meanwhile, as demonstrated above, the matrix
(Hₖ [symbol] +Hₖ)
   has rank ‘1’ or ‘2’ with respect to an arbitrary k. Also, basis vectors of the matrix
(Hₖ [symbol] +Hₖ)
   corresponding to different k are different from each other. Thus, since dₖ>1, all row vectors of the full rank matrix

$${\sum }_{k = 0}^{m} {d}_{k} ( \text{?} + {\underline{\underline{H}}}_{k} )$$

$$\text{?} \text{indicates text missing or illegible when filed}$$

include all basis vector elements of the matrix

$${\sum }_{k = 0}^{m} {d}_{k} ( \text{?} + {\underline{\underline{H}}}_{k} ) . \\ \text{?} \text{indicates text missing or illegible when filed}$$

Therefore, when a part of the elements of
x [symbol] ^{o}
   satisfies −1<aⱼ<1, no case where the (j)th elements of the column vector

$${\sum }_{k = 0}^{m} {d}_{k} ( \text{?} + {\underline{\underline{H}}}_{k} ) {x}_{p}^{o} , \\ \text{?} \text{indicates text missing or illegible when filed}$$

is ‘0’ exists. Thus, no optimal point where a part of the elements of the Shannon performance optimal point
x [symbol] ^{o}
   satisfies −1<aⱼ<1, and another part of the elements satisfies
   |a [symbol] |=1 exists.

To conclude the above-demonstrated results, the maximum Shannon performance in the present invention can be obtained when the circuit of the present invention is constituted by the unit optical detectors satisfying
   |aⱼ|=1,
   that is, the unit optical detectors having a maximum strength for optical detection. Also, the maximum number of Cases where the maximum Shannon performance can be obtained is 2^{N}. Therefore, the conditions for the optimal performance of the present invention and the optimal point
x [symbol] ^{o}
   can be obtained by calculating the maximum Shannon performance value of Equation (9) at
x [symbol]
   corresponding to the 2^{N} number of cases. Thus, the performance can be improved by a maximum of log₂(1+N) times according to Equation (7) of the mathematical maximum limit of the Shannon performance value.

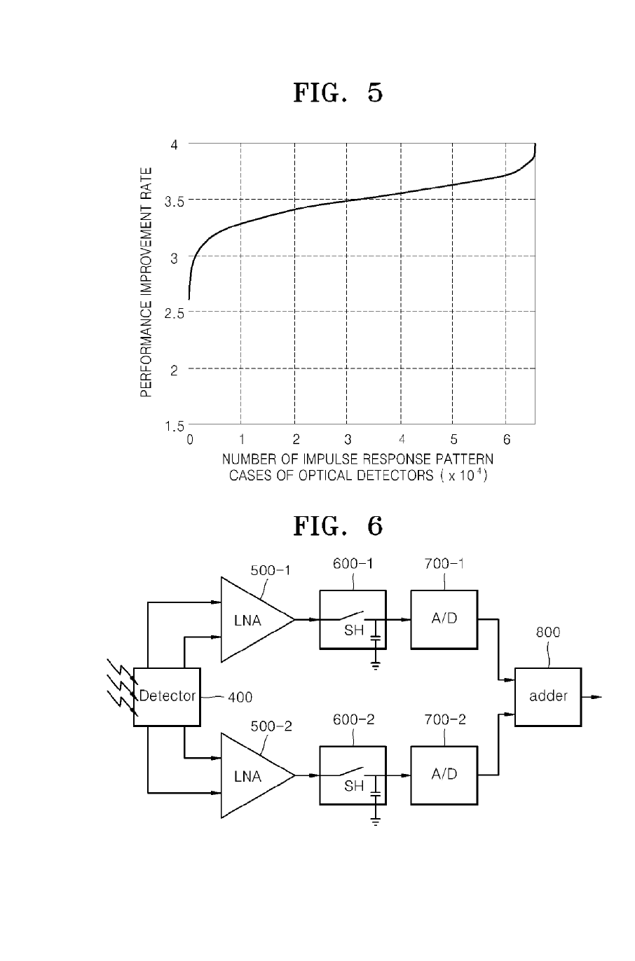

FIG. 5 is a graph illustrating the Shannon performance improvement rate of the multi-aperture optical detector of FIG. 4.

The comparative impulse response vector of the conventional optical detector has a shape in which only one element of the impulse response vector
x [symbol]
   of the present invention is not ‘0’. For a better understanding, the impulse response vector of the conventional optical detector is supposed to be
x [symbol] =[1 0 . . . 0].

### Therefore,

x [symbol]
   has n number of elements like the vector x [symbol] ,
   and only the first element is ‘1’ and the other elements are ‘0’: This model represents a case where only a first unit optical detector is installed in the optical detector of FIG. 4, which leads to the stricture of the conventional optical detector. Also, an equal output resistance of both terminals 300 and 350 of the optical detector 400 consisting of a single optical detector is

zₖ=\sqrt{lₖ/cₖ},

that is, the optical detector has a transmission line characteristic impedance value irrespective of the number of connected unit optical detectors. Therefore, the magnitude of thermal noise of the optical detector of the present invention is the same as that of the conventional unit detector.

FIG. 5 shows a computer simulation on the rate of the Shannon performance of Equation (9) of the optical detector of the present invention, which is modeled as
x [symbol] =[±1 ±1 . . . ±1,0, . . . 0],
   to the Shannon performance of the conventional optical detector, which is modeled as
x [symbol] =[1 0 . . . 0,0, . . . 0],
   with respect to 2¹⁶ number of cases. In FIG. 5, the horizontal axis represents 2¹⁶ number of cases. The vertical axis shows values of the Shannon performance of the present invention divided by the Shannon performance of the conventional optical detector and the values indicate the degrees of performance improvement of the optical detector of the present invention compare to the conventional optical detector. As shown in FIG. 5, when the number of the unit optical detectors are sixteen, the maximum rate of performance improvement is 3.945 (times) near 4.0875 (times), which is the mathematical maximum rate of the performance improvement according to Equation (7) of the mathematical maximum limit of the Shannon performance.
   Although not shown in FIG. 5, The 8
x [symbol]
   row vectors patterns which have the maximum Shannon performance are shown in Equation (16).

[−1+1−1−1−1+1−1−1+1−1−1−1−1+1+1+1], [+1−1+1+1+1−1+1+1−1+1+1+1+1−1−1−1], [−1−1−1+1+1+1+1−1+1+1−1+1+1+1−1+1], [+1+1+1−1−1−1−1+1−1−1+1−1−1−1+1−1], [−1+1−1−1+1−1+1+1+1−1−1−1+1−1−1−1], [+1−1+1+1−1+1−1−1−1+1+1+1−1+1+1+1], [−1−1−1+1−1−1−1+1+1+1−1+1−1−1+1−1], [+1+1+1−1+1+1+1−1−1−1+1−1+1+1−1+1] Equation (16)

FIG. 6 is a circuit diagram of an optical signal detecting circuit including the multi-aperture optical detector of FIG. 4 according to another embodiment of the present invention.

Referring to FIG. 6, the optical signal detecting circuit includes: a multi-aperture optical detector 400 which converts optical signals to electrical signals with a characteristic impulse response feature; two low noise amplifier 500-1 and 500-2 which amplify the electrical signals that are output from two output terminals 300 and 350 of the multi-aperture optical detector; two sample holders 600-1 and 600-2 which sample and maintain the amplified detected signals for digital conversion; two analog to digital (A/D) converter 700-1 and 700-2 which convert the detected signals that are sampled and maintained into digital signals; and an adder 800 which adds the two optical detection electrical signals that are amplified and converted to digital signals to make a single digital signal.

The output terminals 300 and 350 of the multi-aperture optical detector 400 which is installed in the optical signal detecting circuit of FIG. 6 should output the same detected signal sequence having the same phase. For this, the impulse responses that are output from the two output terminals 300 and 350 of the multi-aperture optical detector 400 should be the same. In other words, the following Equation (17) or (18) should be satisfied. Therefore, the impulse response row vector having N elements, which are the impulse responses of the multi-aperture optical detector having N unit optical detectors, should be 180° symmetrical with respect to the element in the middle. That is, the impulse response row vector have mirror symmetry with respect to the element in the middle.

$$\begin{matrix}\begin{matrix}{h}_{l} ( t ) = \text{?} ( t ) \\ = {\sum }_{k = 0}^{N - 1} {a}_{k} δ ( t - ( k + 1 ) {T}_{0} ) \\ = {\sum }_{k = 0}^{N - 1} {a}_{( N - 1 - k )} δ ( t - ( k + 1 ) {T}_{0} )\end{matrix} & Equation ( 17 ) \\ {a}_{k} = {a}_{( N - 1 - k )} , for k = 0 , 1 , L N - 1 \\ \text{?} \text{indicates text missing or illegible when filed} & Equation ( 18 )\end{matrix}$$

When Equation (18) is satisfied, the optical detection electrical signals that are output from the multi-aperture optical detector 400 satisfy Equation (17) and can be added by the adder of the optical signal detecting circuit of FIG. 6.

The optical signal detection circuit of the present invention can effectively increase the strength of signals by adding the electrical signals that are detected by N unit optical detectors using only two amplifiers, sample holders, A/D converter and a single digital adder.

The above-described multi-aperture optical detector or the optical signal detecting circuit of the present invention can have a physically compact small aperture while having a high operating bandwidth and can detect optical signals with a high sensitivity by connecting a plurality of unit optical detectors having a low optical sensitivity.

Also, the multi-aperture optical detector using N unit optical detectors has an information transmission capacity that is a maximum of log₂(1+N) times that of the unit optical detector. Thus, the multi-aperture optical detector of the present invention can be used for optical wireless communicators, millimeter wave communicators, etc., by being combined with a ‘unipolar OFDM’ device or a conventional modulation and demodulation device.

Further, a highly sensitive optical wireless communicator using the multi-aperture optical detector of the present invention can be used in indoor broadband backbones, plant and industrial machine control backbones, and space communications in the future.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention relates to an optical communication device, and more particularly, to an optical detector for direct detection of an optical signal and an optical signal detecting circuit comprising the optical detector. The multi-aperture optical detector or the optical signal detecting circuit of the present invention can have a physically compact small aperture while having a high operating bandwidth and can detect optical signals with a high sensitivity by connecting a plurality of unit optical detectors having a low optical sensitivity.

1. A multi-aperture optical detector comprising:
transmission lines having two output terminals; and
a plurality of unit optical detectors which respectively have random polarities through the transmission lines and are connected in parallel,
wherein optical signals from each of the unit optical detectors are added and output through the two output terminals.

2. The multi-aperture optical detector of claim 1, wherein the unit optical detector comprises:
an objective lens condensing light;
a ball lens condensing again the light that is condensed by the objective lens; and
a photo diode (PD) receiving the light that is condensed by the ball lens and generating an electrical current.

3. The multi-aperture optical detector of claim 2, wherein the photo diode (PD) comprises a depletion layer which receives light and generates an electric current, and a high reverse-bias voltage is applied to the depletion layer.

4. The multi-aperture optical detector of claim 1, wherein the transmission lines are formed by using one of strip lines, microstrip lines, coaxial lines, unshielded twisted pair (UTP) wires, and shielded twisted pair (STP) wires.

5. The multi-aperture optical detector of claim 1, wherein the transmission lines are formed by using elements of a lumped constant circuit including a resistance, a capacitor, and an inductor.

6. The multi-aperture optical detector of claim 1, wherein the two output terminals output the same optical signals having the same phase.

7. The multi-aperture optical detector of claim 1, wherein a matched impedance circuit which is conjugate-matched to the output impedance is formed at one of the two output terminals.

8. The multi-aperture optical detector of claim 1, wherein the output impulse response characteristic of the unit optical detectors has a parallel combination pattern in which several column vectors or row vectors of a Hadamard matrix are combined, and the multi-aperture optical detector can separately detect optical pulse signals transmitted with intervals of a magnitude of the Hadamard matrix.

9. The multi-aperture optical detector of claim 1, wherein the output impulse response characteristic of the unit optical detectors has a parallel combination pattern in which several column vectors or row vectors of an orthogonal matrix are combined, and the multi-aperture optical detector can separately detect optical pulse signals transmitted with intervals of a magnitude of the orthogonal matrix.

10. The multi-aperture optical detector of claim 1, wherein the multi-aperture optical detector having N unit optical detectors has an optical detecting capacity as high as a maximum of log₂(1+N) times the optical detecting capacity of a single optical detector.

11. An optical signal detecting circuit comprising:
a multi-aperture optical detector of claim 1;
two low noise amplifiers (LNAs) that are respectively connected to the two output terminals;
two sample holders which sample and maintain the signals that are output from each of the LNAs;
two analog to digital (A/D) converters which convert the signals that are sampled and maintained in each of the sample holders into digital signals; and
an adder which adds the digital signals from each of the A/D converters.

12. The optical signal detecting circuit of claim 11, wherein the transmission lines are formed by using one of strip lines, microstrip lines, coaxial lines, unshielded twisted pair (UTP) wires, and shielded twisted pair (STP) wires, or by using a lumped elements of a resistance, a capacitor and an inductor.

13. The optical signal detecting circuit of claim 11, wherein the impulse response row vector have mirror symmetry with respect to the element in the middle.

14. The optical signal detecting circuit of claim 11, wherein the information transmission capacity of the optical signal detecting circuit in which N unit optical detectors are used for the multi-aperture optical detector is as high as log₂ (1+N) times the information transmission capacity of the optical signal detecting circuit in which a single unit optical detector is used.
